(19) United States
(12) Patent Application Publication
(10) Pub. No.: US 2022/0088495 A1
(43) Pub. Date: Mar. 24, 2022

(54) VIDEO GAMING SUPPORT DEVICE

(71) Applicant: Andrew Shier, Newmarket (CA)

(72) Inventor: Andrew Shier, Newmarket (CA)

(21) Appl. No.: 17/478,833

(22) Filed: Sep. 17, 2021

(30) Foreign Application Priority Data
Sep. 21, 2020 (CA) 3093783

(51) Int. Cl. A63F 13/98

(52) U.S. Cl. CPC A63F 13/98

(57) ABSTRACT

Provided is a device for supporting a user while playing video games. The device has a height adjustable support base and an angle adjustable platform mounted to the support base. The device supports a user's arms during a forward leaning “engaged gaming position”.

### CROSS-REFERENCE TO RELATED APPLICATION

This application claims the benefit of priority to Canadian Patent Application No. 3,093,783 filed on Sep. 21, 2020, which is herein incorporated by reference in its entirety.

### TECHNICAL FIELD

This application is related to a video gaming support device and more specifically, to video game accessories.

### BACKGROUND OF THE INVENTION

There currently exist in the market chairs designed for video gaming which provide back support when the user is in an upright sitting position. In this position, the user leans back and holds the video game controller with elbows tucked, with most of the user's weight resting on the back muscles which are supported by the chair. This may be referred to as a “casual gaming position”.

However, during more engaged gaming sessions where focus is required, the user may change into an “engaged gaming position”. The engaged gaming position is typically a slouched-forward position with elbows-on-knees to allow for heightened focus and liberation of hand muscles for better responsiveness. In this position, tension can build around the neck, shoulder and arm muscles. The current gaming focused products on the market, which include various chairs designed for lower back support, do not provide the user with sufficient support, especially of the neck, shoulders and arms, in the engaged gaming position.

This is a common problem especially with respect to living room console video gaming, where the typical user is not seated on an ergonomic chair, but a couch with even less support for an engaged gaming position.

### SUMMARY OF THE INVENTION

In an embodiment, there is disclosed a device having a height adjustable base and an angle-adjustable incline platform to provide a user with sufficient support to maintain an engaged gaming position, as defined above. This may prevent muscle tightness and soreness experienced after long sessions of engaged gaming by transferring the load to device and the lower back muscles.

The height adjustable base may consist of a series of interlocking blocks which provide flexibility to accommodate users of different heights while at the same time providing sufficient stability to support the weight of a user leaning on it. Depending on the embodiment, the interlocking blocks may form part of, or the entirety of the support base. Each interlocking block may have recesses and protrusions which correspond to the protrusions and recesses of other interlocking blocks to allow for secure yet removable connections between the blocks. Mounted on top of the support base is a platform for supporting the arms of the user. The angle of the platform may be adjusted to suit the user's individual needs.

In some embodiments, the support base may have a cavity to allow storage of objects. In other embodiments, a lower portion of the support base may be fully detached from the rest of the device to act as a standalone piece of furniture, similar to an ottoman. In other embodiments, the lower portion of the support base may flared or otherwise expand in surface area towards the bottom.

In some embodiments, the angle of the platform may be adjusted through an incline adjustment bar extending from the platform which securely engages various ridges or protrusions extending from the top surface of the support base. In other embodiments, the angle of the platform may be adjusted through the placement or removal of a removable block, which may be of a triangular shape. In other embodiments, the angle of the platform may be adjusted through electromechanical means such as an adjustable motor.

The foregoing summary is not intended to summarize each potential embodiment or every aspect of the subject matter of the present disclosure.

These and other aspects of the device and method are set out in the claims, which are incorporated here by reference.

### BRIEF DESCRIPTION OF DRAWINGS

Embodiments will now be described with reference to the figures, in which like reference characters denote like elements, by way of example, and in which:

FIG. 1 is an exploded view of a video game support device, according to one embodiment.

FIG. 2 is a perspective view of the device of FIG. 1.

FIG. 3 is another perspective view of the device of FIG. 1.

FIG. 4 is a close-up perspective view of an interlocking block, according to one embodiment.

FIG. 5 is a perspective view of a video game support device, according to another embodiment.

FIG. 6 is a side view of the video game support device of FIG. 5, as being operated by a user.

FIG. 7A is a close-up perspective view of a platform being supported by a removable block at a first angle, according to another embodiment.

FIG. 7B is a side view of the embodiment of FIG. 7A.

FIG. 8A is a close-up perspective view of a platform being supported by the removable block at a second angle, according to the embodiment of FIG. 7A and 7B.

FIG. 8B is a side view of the embodiment of FIG. 8A.

FIG. 9 is a close-up perspective view of a platform without the support of a removable block, according to the embodiment of FIGS. 7A-8B.

FIG. 10 is a top down view of a video game support device, according to another embodiment.

FIG. 11 is a side view of the video game support device of FIG. 10, as being operated by a user.

FIG. 12 is a perspective view of the device of FIG. 11.

### DETAILED DESCRIPTION

Immaterial modifications may be made to the embodiments described here without departing from what is covered by the claims.

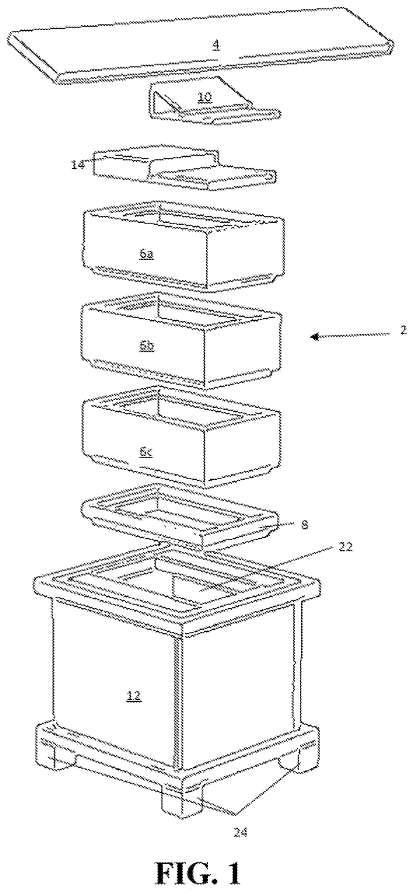

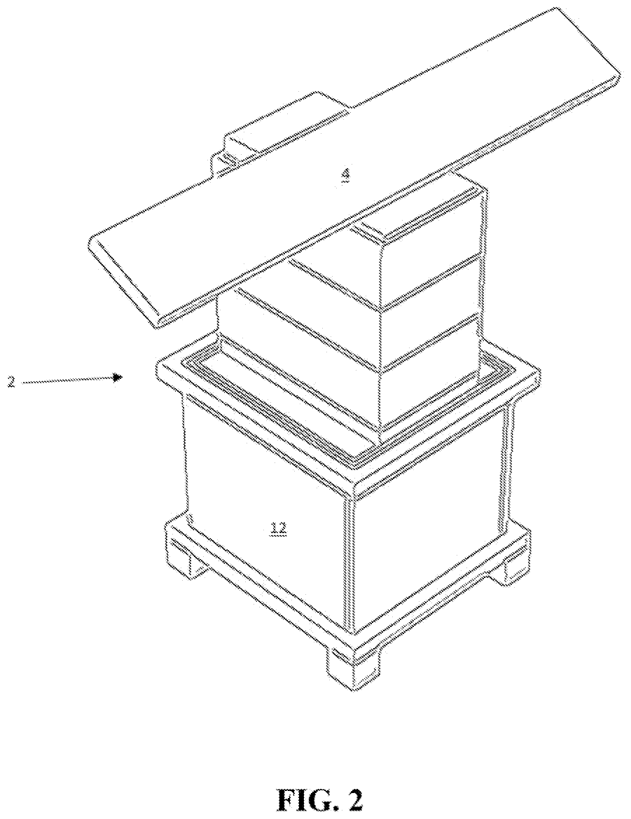

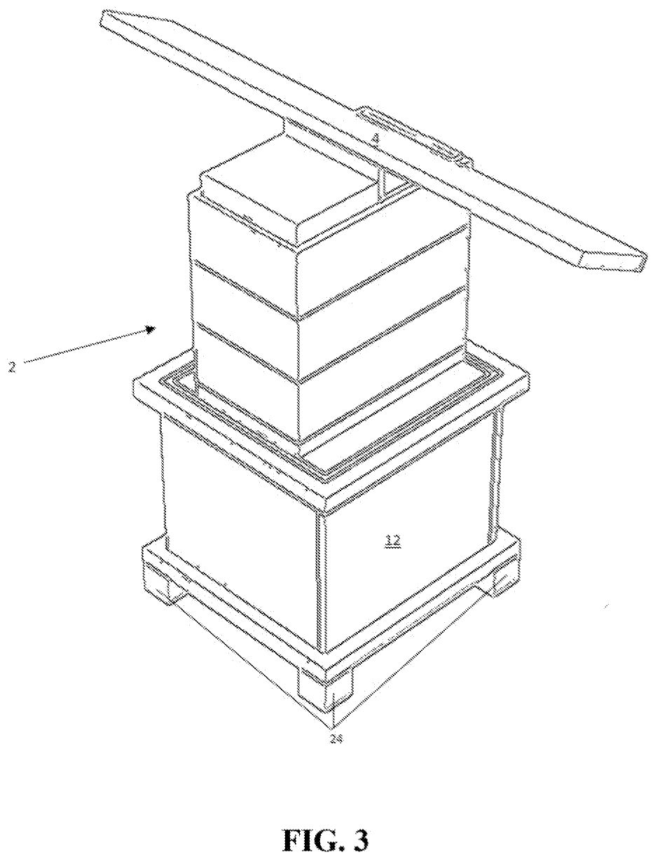

Shown in FIG. 1 is an exploded view of one embodiment of the invention, having a support base 2 which comprises a lower portion 12, a series of interlocking blocks 6a-c and 8 for height adjustment, and a top portion 14 on which a platform 4 is mounted. Shown in FIGS. 2 and 3 are two separate perspective views of the same device. In this embodiment, the angle of the angle-adjustable platform 4 is adjusted through an adjustable wedge device 10, although as will be explained below, other means of angle adjustment will be possible. There are also optional legs 24 which may be used to provide additional stability.

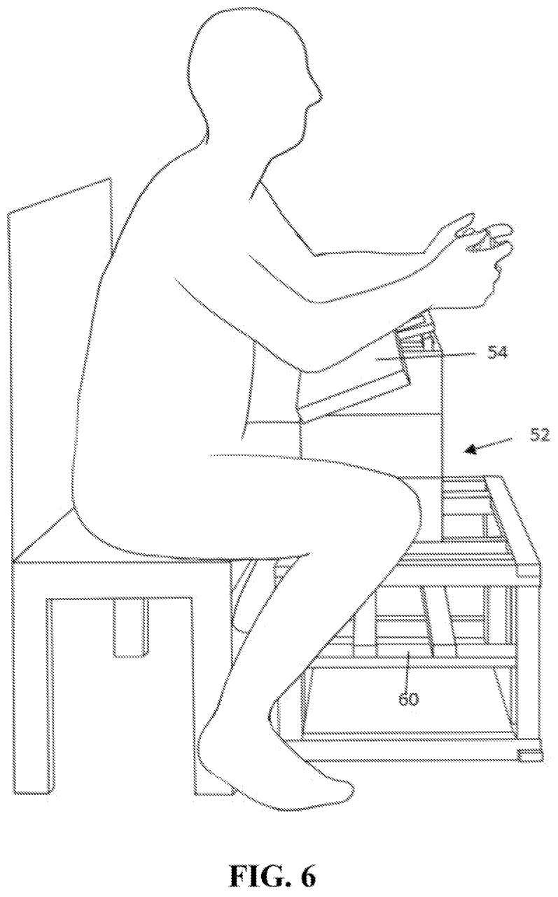

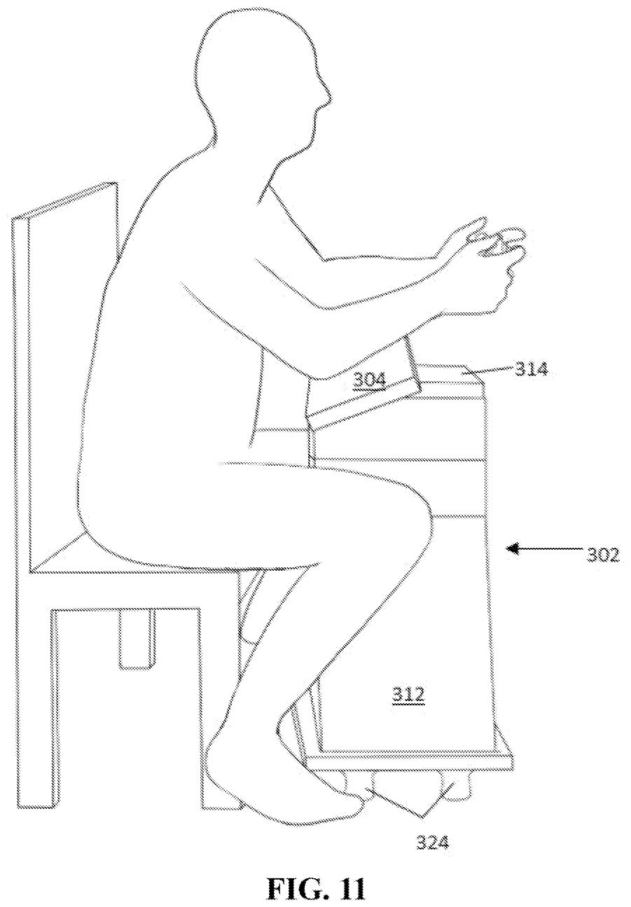

Shown in FIG. 6 is a side view of an embodiment of the device as being used by a user during the engaged gaming position. In this position, the user sits in a substantially upright position, leans forward and rests their arms on the platform 54 while their hands remain free to manipulate the gaming controller. In this position, the weight load of the user is distributed between the device itself as well as the user's lower back. It is important that the device is set at the proper height. If the platform 54 is too high, weight may be distributed unevenly onto the lower back of the user, causing back pain, or the platform may not be able to provide sufficient support for the arms, resulting shoulder strain or a condition otherwise known as “mouse shoulder”. On the other hand, if the platform 54 itself is too low, the user may be more inclined to rest their entire weight onto the platform, which also has a negative impact as excess pressure from the platform on the arms may lead to a condition known as cubital tunnel syndrome. The appropriate height for the support base 52 will depend on the user's own height and general gaming posture, and accordingly, an easy yet secure means for height adjustment is necessary. A similar embodiment shown in FIG. 11 includes a flared lower portion 312 of the support base 302 which may be used to better accommodate the positioning of a user's legs and knees.

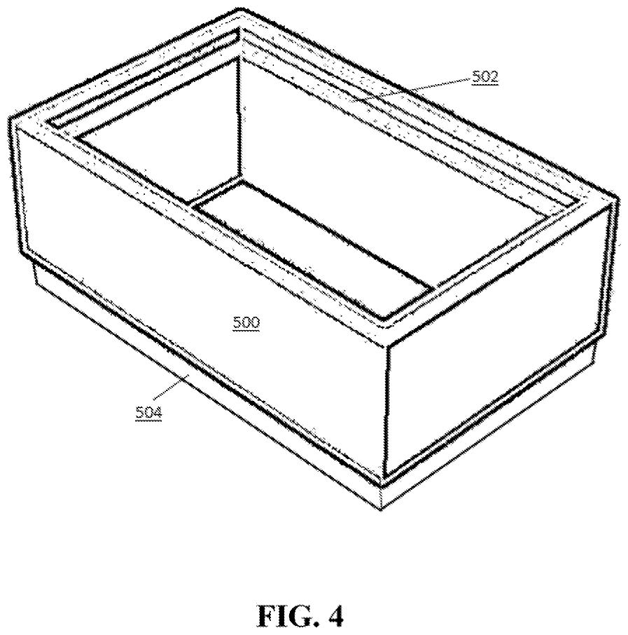

As shown in FIG. 1, incremental height adjustment of the support base 2 may be achieved through a series of interlocking blocks 6a-c and 8. As shown in FIG. 4, each block 500 may have a recess 502 and protrusions 504 at respectively opposed top and bottom ends, such that they are able to interlock with other blocks. In this particular embodiment, the protrusion 504 and recess 502 cover the entire diameter of the block 500 to allow a secure grip with other interlocking blocks. Through testing, it has been shown that the use of interlocking blocks as part of the base offers a combination of stability and adjustability. The interlocking feature allows the blocks to connect with one another without the risk of lateral movement, while use of protrusions and recesses allow for easy removal and addition of blocks for height adjustability. Other height adjusting means such as adjustable/extendible arms or supports may not provide the user with sufficient stability which is necessary during sessions of high focus gaming. It is imperative that the platform remains fully stable without any movement along the pitch or roll axes, because if the user is forced to compensate in any way for balance in the engaged gaming position, it may result in muscle soreness or injury. The blocks may be composed of a hard material such as wood or hard plastic, in order to provide the necessary stability.

Any number of interlocking blocks may be used to reach the desired height for a user. Such as shown in FIG. 1, the interlocking blocks may also be of varying sizes themselves for greater height control; for example, taller blocks 6a-c may be offered along with shorter blocks 8 to allow users to fine-tune the height adjustment. In the exemplary embodiment shown in FIGS. 1 to 3, support base 2 is comprised of three large blocks 6a-c and one smaller block 8. If needed, additional blocks may be purchased for additional height or adjustability.

As also shown in FIGS. 1 to 3, mounted to the top of the support base 2 is a platform 4 for supporting the user's arms in the engaged gaming position. Ideally, platform 4 is a sturdy one piece material such as a hard plastic, wood or even metal which is securely mounted to the support base. Platform 4 may also be formed from two or more separate pieces as opposed to one piece for ease of manufacturing, assembly and transport. However, if this is case, the two or more separate pieces should be securely joined together to form one continuous platform during use, while not allowing any individual movement between the separate pieces.

Similar to height adjustment, an important aspect of the present device is the ability to adjust the angle of the platform to suit the individual user's needs.

Based on experimentation, it has been determined that the ideal angle of incline is one which allows the user to form and maintain close to a 90 degree angle with their elbows while leaning in. Accordingly, angle for the platform itself may be somewhere between 0 degrees (flat) and 30 degrees. Outside of this range, it may result in insufficient support for the engaged gaming position and result in potential back or shoulder pains as discussed above.

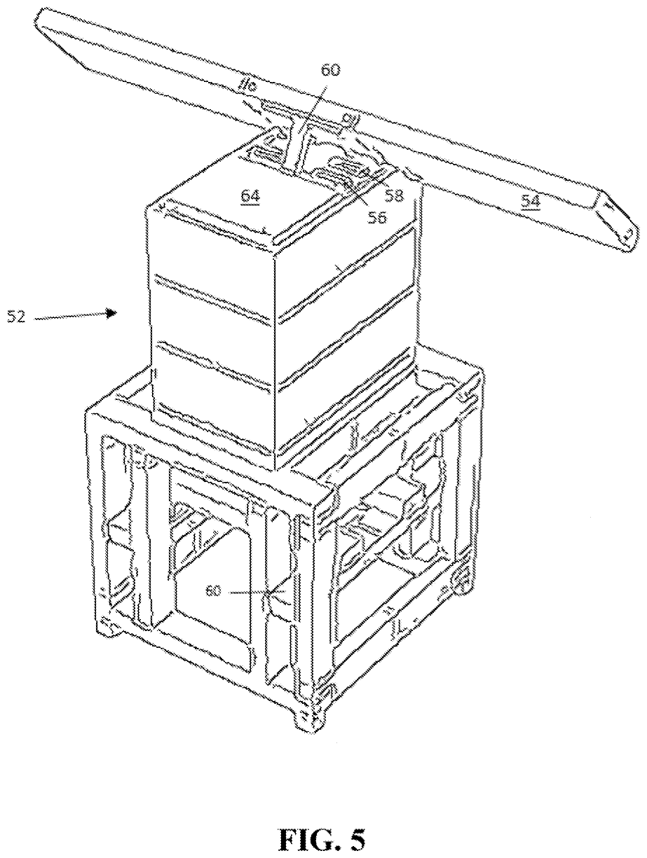

Shown in FIG. 5 is one method of angle adjustment of the platform 54, which includes a hinged incline adjustment bar 60 mounted behind platform 54 which engages a series of ridges 56 and 58 along the top portion 64 of the support base 52. The ridges are designed such that they stop the adjustment bar from further movement even under pressure, and thus providing a stable support for the platform. Having a series of ridges along the top surface of the support base allows the platform to be adjusted and supported at various angles. There may also be a stopper mounted on the top surface of the support base to prevent the platform from sliding toward the user.

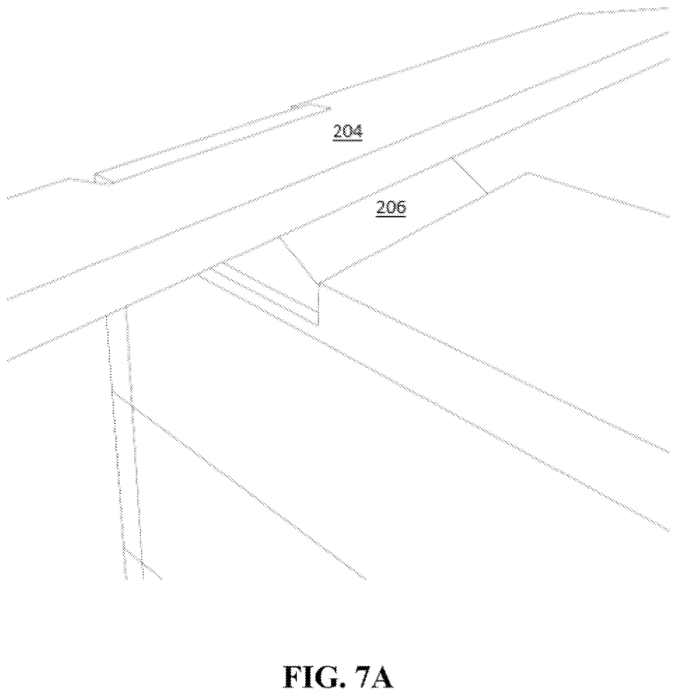

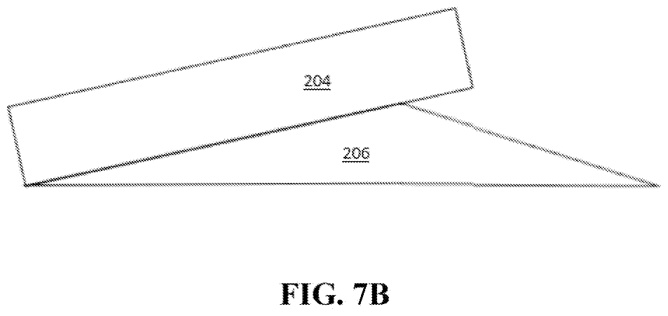

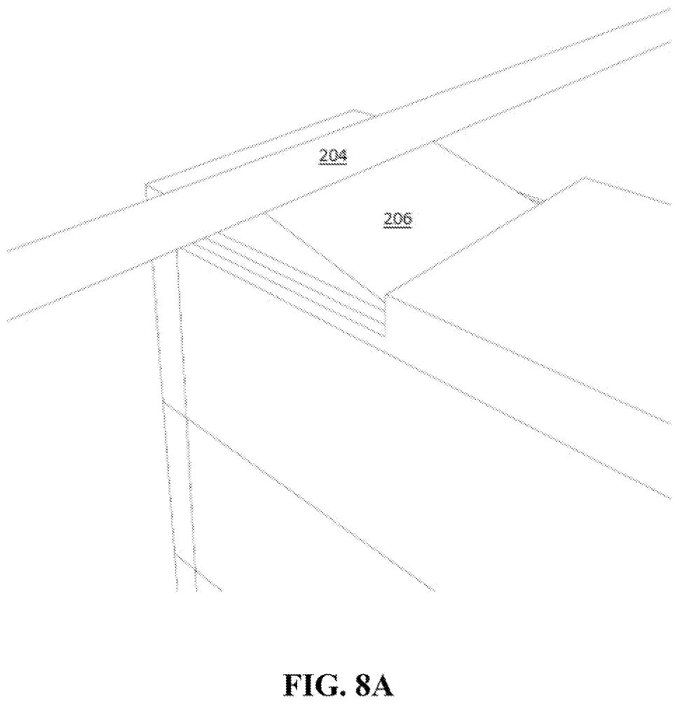

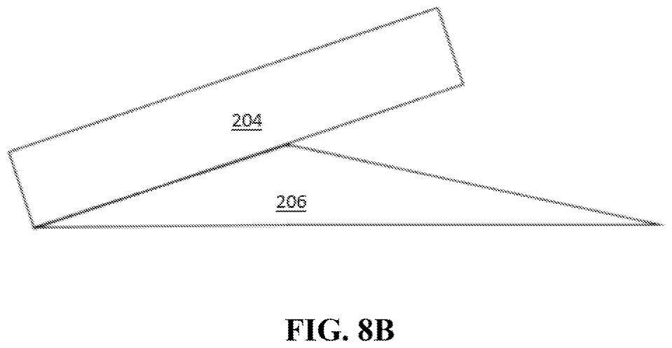

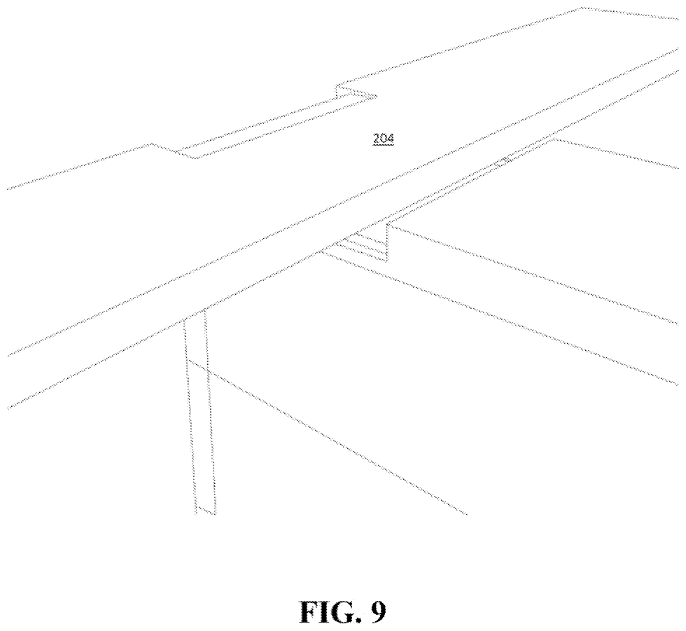

Shown in FIGS. 7A, 7B, 8A, 8B and 9 is yet another method of platform adjustment which uses a removable block for angle adjustment. In FIGS. 7A and 7B, an obtuse triangular block 206 is placed in a first position where the angle of incline of platform 204 is approximately 15 degrees. In FIGS. 8A and 8B, the position of the triangular block 206 is reversed, in which the platform 204 rests on a slightly steeper incline, which is approximately 30 degrees. In FIG. 9, the block is removed, which results in a 0 degree incline (flat) platform 204. As discussed above, a platform angle between 0 degrees to 30 degrees in most cases may provide the user with adequate support and reduce the potential for back or shoulder strain. However, the angles may be further customized to suit the individual needs of the user, and while a triangular block is shown in this embodiment, the block may also be manufactured in different shapes (for example, trapezoids) or having different angle combinations to provide the user with further adjustment options. There may also be a stopper mounted on the top surface of the support base to prevent the platform from sliding toward the user.

It should be noted that the methods described above are only some of the ways of adjusting the angle of the platform. In other embodiments, the angle of the platform may be adjusted through an electromechanical means such as by way of an adjustable motor, or through other mechanical means such as a length adjustable incline adjustment bar.

Other optional features include attaching a soft material (e.g., a cushion) to the user facing surface of the platform to provide additional comfort for the user's arms and elbows.

In some embodiments, a portion of the support base may include a cavity 22 to allow for storage of gaming peripherals or books when not in use, as shown in FIG. 1. The area of the cavity may be designed to be smaller than the length and width of each interlocking block so as to not compromise the overall stability of the support base. Alternatively, there may also be a recess near the top portion of the cavity designed to securely engage the protrusions extending from the bottom of the interlocking blocks. Furthermore, as shown in FIGS. 5 and 6, the lower portion of the support base 52 may also be hollow with a rack 60 for supporting peripherals and books.

It should be noted that other dimensions and variations other than those shown in the drawings can also be used—for example interlocking blocks may form the lower portion of the support base rather than the middle. In some embodiments, the lower portion of the support base is fully detachable from the rest of the device, and can form a standalone piece of furniture similar to an ottoman or coffee table.

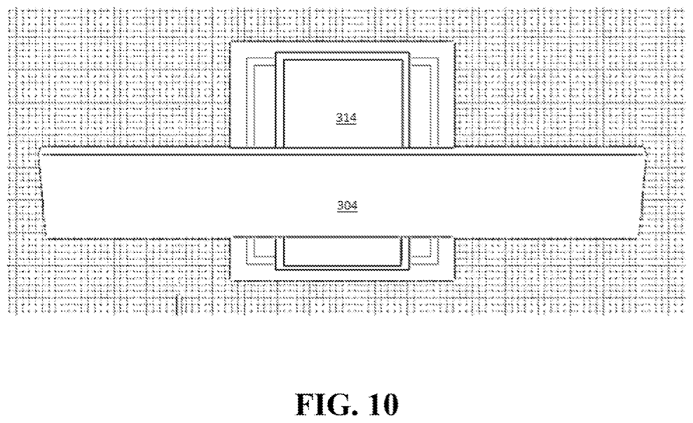

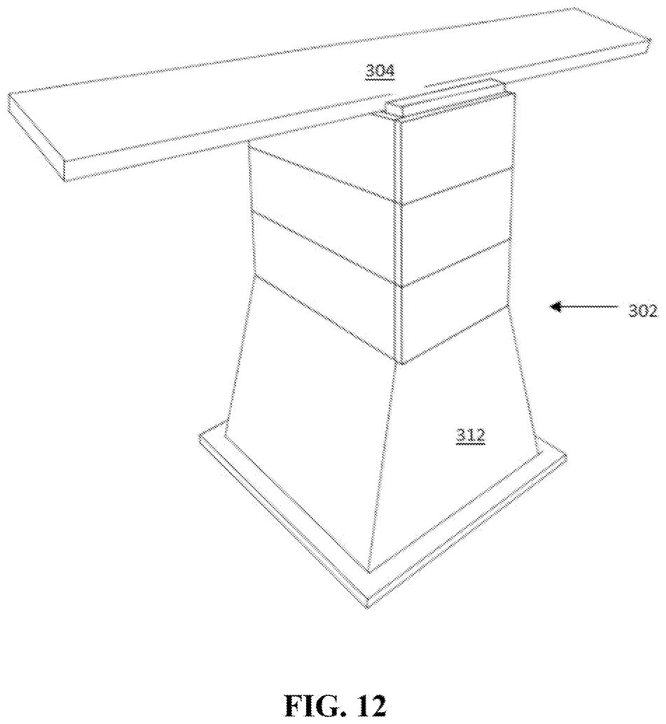

In other embodiments, as shown in FIGS. 10 to 12, the lower portion 312 of the support base 302 may be flared to potentially provide a more comfortable user experience by creating a more natural position for the knees and legs of the user. In this embodiment, the increase in surface area as a result of the flared lower portion may also increase stability under pressure during use.

In some embodiments, additional stability may be provided through the addition of legs 24 mounted to the lower portion of the support base, as shown in FIGS. 1 and 3, and legs 324 in FIG. 11. As emphasized above, stability is paramount—any wobble or shift in the device during use may cause the user to unnecessarily and subconsciously engage core muscles and thus suffer sprains or other injuries. On hard surfaces, support legs may be able to provide this added stability while also minimizing damage to the floor. However, in other embodiments as shown in FIGS. 6 to 8, there are no legs, which may reduce cost of production but also provide more stability on certain softer surfaces such as carpets or rugs. Height adjustable legs may also be used for balance or minute height adjustments to supplement the height adjustment provided by the interlocking blocks.

Additional optional features may be included in certain embodiments. For example, as shown in FIG. 10, there may be provided on the top surface 314 of the support base 302 and adjacent to the platform 304 a resting area for the user to place their controllers or other gaming accessories.

In other embodiments, the size of the platform may be expanded to allow not only the user's arms, but also a keyboard and mouse to also be placed directly on the platform to provide support not only for console gamers, but also those who play games using a personal computer.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

What is claimed is:

1. A device for supporting a user while playing video games comprising:
a support base, the support base comprising an upper portion and a lower portion, the support base further comprising at least one interlocking block, wherein the number of the interlocking block is N, wherein N is a positive integer; and
an angle-adjustable platform mountable to the upper portion of the support base, wherein the angle-adjustable platform is adapted to support a user's arms while the user is seated.

2. The device of claim 1, further comprising:
an adjustment bar extending from the angle-adjustable platform, and
a plurality of protrusions spaced along the upper portion of the support base,
wherein the protrusions are adapted to securely engage the adjustment bar to provide support for the angle-adjustable platform at various angles.

3. The device of claim 1, further comprising:
a removable block mountable to the upper portion of the support base for supporting the angle-adjustable platform,
wherein the removable block is adapted to support the angle-adjustable platform at a plurality of angles based on placement of the removable block.

4. The device of claim 3, wherein the removable block comprises a triangular shape.

5. The device of claim 1, wherein the interlocking block comprises a protrusion and recess at opposed top and bottom ends of the interlocking block, each protrusion and recess adapted to respectively securely engage the recess and protrusion of another interlocking block.

6. The device of claim 1, wherein the lower portion of the support base is flared.

7. The device of claim 1, further comprising a plurality of support legs extending downward from the lower portion of the support base.

8. The device of claim 7, wherein the support legs are height adjustable.

9. The device of claim 1, wherein the lower portion of the base further comprises a cavity for item storage.

10. The device of claim 1, wherein the angle-adjustable platform has adjustable incline range of between 0 to 30 degrees relative to the upper portion of the support base.

11. The device of claim 1, further comprising a depressible material mounted to a user-facing surface of the angle-adjustable platform.

12. The device of claim 1, wherein the N number of the interlocking block are stacked vertically.
